(19) United States
(12) Patent Application Publication
(10) Pub. No.: US 2025/0389483 A1
(43) Pub. Date: Dec. 25, 2025

(54) Dryer for Collapsible Water Containers

(71) Applicant: Michael Fallacara, Cape Coral, FL (US)

(72) Inventor: Michael Fallacara, Cape Coral, FL (US)

(21) Appl. No.: 18/751,721

(22) Filed: Jun. 24, 2024

(51) Int. Cl. F26B 9/00; A45D 20/12; F26B 21/00

(52) U.S. Cl. CPC F26B 21/008; A45D 20/122

(57) ABSTRACT

A tool designed to efficiently dry collapsible water containers by attaching to a blow dryer addressing the challenge of slow and ineffective drying due to containers' narrow openings. This attachment comprises a narrow end to fit into the container's opening, a threaded section for secure attachment, and a flared opening to direct airflow from a blow dryer. Additionally, small openings around the narrow end disperse airflow into the container, while larger openings at the bottom disperse airflow across the container's base. The attachment, made from heat-resistant materials like plastic is lightweight and portable. It accommodates various blow dryer nozzle sizes and creates a tight seal to prevent air leakage. The side vents along the attachment efficiently disperse moist air out of the container. It is compatible with blow dryers featuring cool or cold airflow settings, and expedites the drying process, ensuring thorough drying and preventing issues like mold growth.

### BACKGROUND

### Field of the Invention

The present invention pertains to a water-drying apparatus, particularly an attachment designed for use with various types of blow dryers. The attachment expedites the draining and drying process of water containers, specifically collapsible water containers.

### Description of the Related Art

Collapsible water containers have revolutionized the way people store and transport water in various outdoor and emergency situations. These containers, typically made from lightweight, flexible materials such as plastic or silicone, have gained popularity due to their compactness and ease of storage when empty. Whether for camping trips, hiking adventures, or emergency preparedness kits, collapsible water containers have become an essential part of outdoor gear.

The market for collapsible water containers has experienced substantial growth in recent years. Market reports indicate that the global market size for collapsible water containers exceeded and this growth is driven by several factors, including increased participation in outdoor recreational activities, rising concerns about hydration, and the convenience of collapsible containers in comparison to traditional rigid water bottles.

Despite their many advantages, collapsible water containers pose a unique challenge when it comes to drying. Due to their flexible nature and often narrow openings, it can be difficult to completely dry the interior after use. Trapped moisture inside the container can lead to mold and bacteria growth, compromising hygiene and potentially causing health issues. Therefore, ensuring thorough drying of collapsible water containers is essential for maintaining their usability and longevity.

Various methods have been devised to address the drying issue of collapsible water containers. Some users employ drying racks specifically designed for these containers, which allow them to air dry in an open position. Others utilize absorbent materials placed inside the container to soak up residual moisture. Portable fans or heaters are also sometimes used to expedite the drying process. However, these methods can be cumbersome, time-consuming, and may not always provide optimal results, especially for containers with complex shapes or limited access to the interior.

By looking at prior art, multiple advancements have been seen in bottle drying and cleaning apparatuses. For instance, a WO patent 1,997,029859A1 relates to a method of cleaning drink bottles in which the bottles are acted on by a cleaning agent containing active oxygen. This ensures thorough and satisfactory removal of mold.

A method for washing bottles bearing WO patent 1,997,020645A1 relates to a method for cleaning returnable beverage bottles, particularly plastic bottles comprising the following steps: pre-treating the bottles with a concentrated cleaning formulation comprising more than about 0.5% by weight of an alkaline agent, followed by removing the cleaning formulation and soil in one or more subsequent stages.

A Bottle drying apparatus bearing U.S. Pat. No. 4,683,009 discusses a method and apparatus for high speed drying of the interior surfaces of a plurality of plastic bottles without causing heat deterioration of the bottles. Bottles to be dried are heated through application of a heated liquid to the exterior surface thereof while a gas jet is simultaneously directed into the bottle interior. Method and apparatus for continuously moving and rotating the bottles during the drying process is also described.

Additionally, U.S. Pat. No. 2,015,0300739A1 relates to drying apparatus for drying containers, WO patent 2,017,137637A2 for drying containers, and U.S. Pat. No. 5,271,164A relates to method and apparatus for drying containers providing advancements in their own ways.

Existing solutions for drying collapsible water containers often fall short in terms of convenience, efficiency, and portability. Users may find it inconvenient to set up and use separate drying apparatuses, especially when camping or traveling. Additionally, these solutions may not be compatible with various types of blow dryers commonly available in households, limiting their usability.

In response to these challenges, the present invention introduces a novel blow dryer attachment specifically designed for drying collapsible water containers. This attachment comprises two parts: the first part serves as a connector to the blow dryer, while the second part, connected to the first, performs the drying function. By harnessing the airflow generated by the blow dryer, this attachment expedites the drying process, ensuring thorough drying of water containers in a convenient and efficient manner.

This invention addresses the inefficiency and inconvenience associated with drying collapsible water containers by providing a dedicated blow dryer attachment. By utilizing the airflow from the blow dryer, the attachment ensures thorough drying of water containers, thereby preventing mold and bacteria growth and extending their lifespan. This innovative solution offers portability, versatility, and effectiveness, enhancing the user experience and promoting hygiene in outdoor and emergency situations.

None of the previous inventions and patents, taken either singly or in combination. is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of assembly for drying water containers.

It is also the objective of the invention to provide an assembly that can be attached to any type of blow dryer and provides drying of the container.

Another object of this invention is to provide a new and improved assembly that offers versatility, wherein the attachment tool is compatible with any type of hairdryer featuring a cool or cold setting, making it convenient for users to utilize their existing household appliances.

It is an object of the invention to provide a two-part device that can be assembled and disassembled easily and therefore can be easily stored.

It is also the objective of the invention to provide efficient drying by utilizing the blow dryer attachment tool, collapsible water containers can be dried in minutes rather than days, saving time and frustration for users.

It is moreover the objective of the invention to ensure thorough drying with a specially designed airflow system to ensure that moisture is quickly and thoroughly removed from the bottom up to the sides of the container, preventing the growth of mold and bacteria.

It is also the objective of invention to promote hygiene by drying collapsible water containers quickly and effectively, the invention helps maintain hygiene standards, reducing the risk of contamination and ensuring safe water storage.

It is another object of the invention to provide a structure i.e. portable and can be carried easily.

Yet another object of the present invention is to provide a structure that is relatively inexpensive to produce so that ownership is available to a substantial majority of dog owners

It is a further aspect of the present invention to provide a new and improved assembly that is durable and reliable and can sustain its effectiveness after multiple and consistent uses.

Thus, it is the objective to provide an assembly that can be attached to any type of dryer to provide drying functionality. Other aspects, advantages, and novel features of the present invention will become apparent from the detailed description of the invention when considered in conjunction with the accompanying drawings.

This Summary is provided merely for the purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a vertical view of the first part of the collapsible water containers dryer as per an embodiment of the present disclosure.

FIG. 2 is a vertical view of the second part of the collapsible water containers dryer as per an embodiment of the present disclosure.

FIG. 3 is a horizontal view of both parts as per an embodiment of the present disclosure.

FIG. 4 is a front view of both parts as per an embodiment of the present disclosure.

FIG. 5 is a back view of both parts as per an embodiment of the present disclosure.

FIG. 6 shows both parts joined together as per an embodiment of the present disclosure.

FIG. 7 is a perspective view of the assembly installed in a collapsible water container as per an embodiment of the present disclosure.

FIG. 8 is a working view as per an embodiment of the present disclosure.

FIG. 9 is another working view of the dryer as per an embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Collapsible water containers, such as bottles, bags, or cubes, offer numerous conveniences and benefits to consumers due to their portability and space-saving design. However, a common drawback is the lack of a large opening, making it difficult to manually drain and dry them effectively. This often leads to a lengthy process of drip drying, causing frustration and impatience, and potentially resulting in containers being stored away while still damp, leading to issues such as mold growth.

To address this challenge, the blow dryer attachment tool was invented to be used with any type of hairdryer featuring a cool or cold setting, enabling users to dry containers in minutes rather than days. The tool is made from durable, heat-resistant materials such as plastic or silicone, ensuring longevity and safety during use.

The current invention as per its preferred embodiments aims to provide a two-part structure that is joint together to form one part. The structure can be fixed to any type of blow dryer to perform drying.

In one embodiment, the invention provides an attachment mechanism for quickly and easily attaching to and detaching from a main structure i.e., in this case a blow dryer. The attachment mechanism has a housing with a slot, a movable retention member and a means for biasing the retention member at least partially in the slot. The attachment mechanism also has a release mechanism that is connected to the retention member such that when the release mechanism is engaged the retention member is substantially removed from the slot.

In another embodiment, the invention provides an attachment feature attached to the blow dryer. The attachment feature has a housing, an opening in the housing for receiving a structure, and a releasable retention means for selectively retaining the structure in the opening.

In another embodiment, the invention provides an attachment member having a housing, a slot in the housing and a retention member having a first end and second end. The first end of the retention member retractably extends into the slot. A release mechanism is connected to the second end of the retention member. Once a release mechanism is not engaged, the first end of the retention member extends into the slot and when the release mechanism is engaged, the first end of the retention member is at least partially retracted from the slot.

In one embodiment, the invention provides an attachment mechanism for quickly and easily attaching to and detaching from a structure. The attachment mechanism is easy to attach and detach and can be connected to any type of blow dryer.

In one embodiment, the blow dryer attachment tool is equipped with ten specially designed side vents that efficiently disperse the moist air out of the container. Without these vents, the air would simply push back up into the blow dryer, creating an ineffective airflow. However, with the blow dryer attachment tool, the cool air is jetted into the container, dispersed to rapidly dry it, and then removed through the side vents while fresh air is simultaneously introduced.

This efficient cycle of airflow ensures very fast drying, completing the process in mere minutes. The placement of the five bottom holes, the design of the side release vents, and the flared opening of the tool all contribute to creating a tight seal when attached to the container. This tight seal ensures that the airflow is directed precisely where it is needed, maximizing the effectiveness of the drying process.

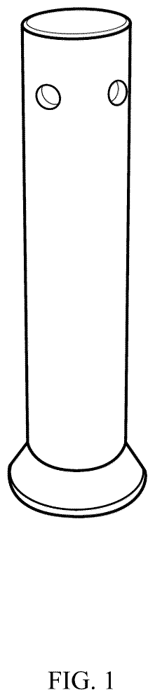

The assembly can be further understood by looking at the provided drawings. FIG. 1 illustrates the first part of the collapsible water containers dryer, designed to fit securely into the container's narrow opening. The first part features a narrow end with small openings around its circumference for dispersing airflow into the container. This part is essential for ensuring the initial entry of air into the container, facilitating the drying process from the inside.

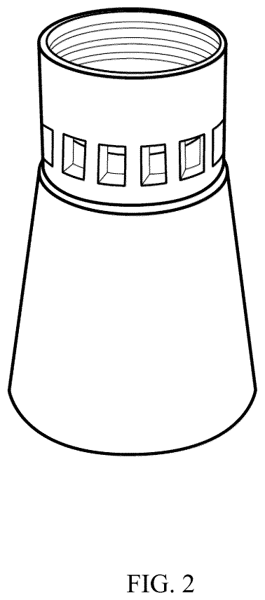

FIG. 2 shows the second part of the assembly, which includes a flared opening to direct airflow from a blow dryer. The flared section is equipped with a threaded area for secure attachment to various blow dryer nozzles. This part ensures a tight seal to prevent air leakage and maximize airflow into the container.

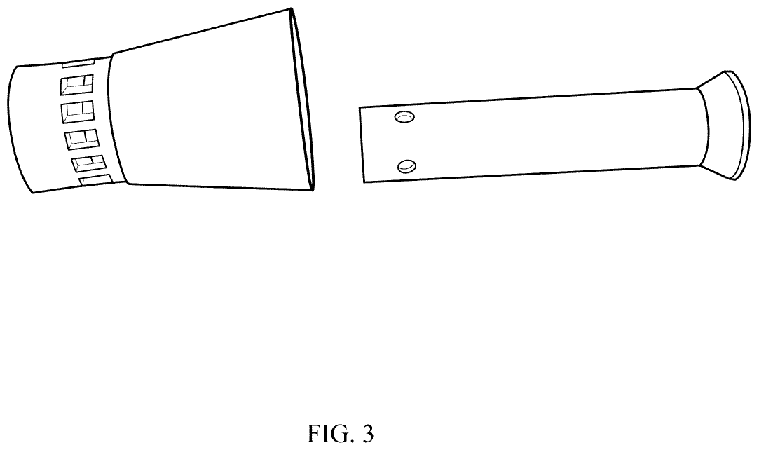

FIG. 3 provides a horizontal view of both parts of the collapsible water container dryer, highlighting their alignment and how they connect.

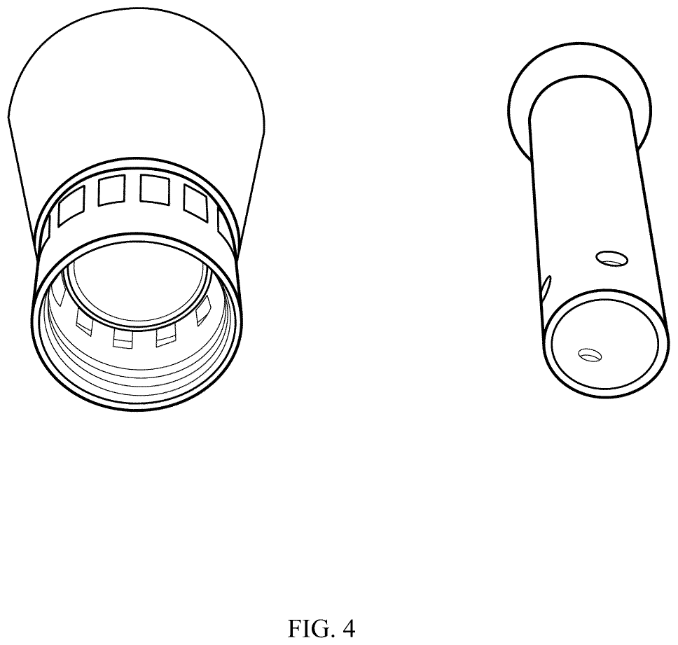

FIG. 4 depicts the front view of the assembled parts of the dryer, illustrating the flared opening of the second part and the narrow end of the first part. This view emphasizes the design meant for efficient airflow direction and secure attachment to a blow dryer.

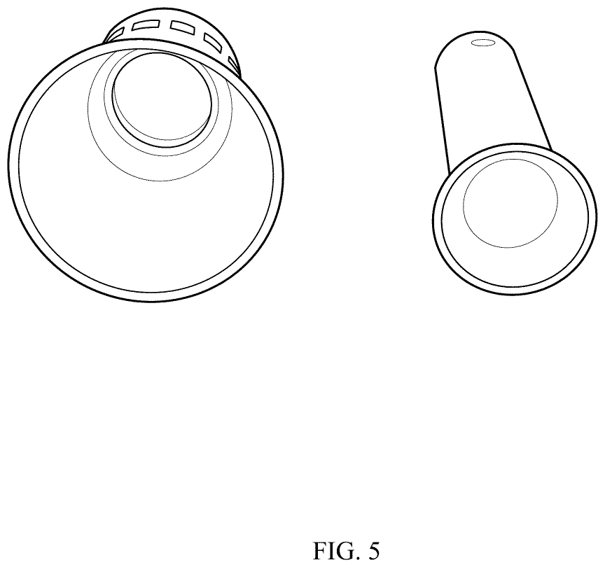

FIG. 5 illustrates the back view of both parts, providing a perspective on the threaded section designed to accommodate various blow dryer nozzle sizes. The back view also shows the small and large openings intended for effective dispersion of airflow within the container.

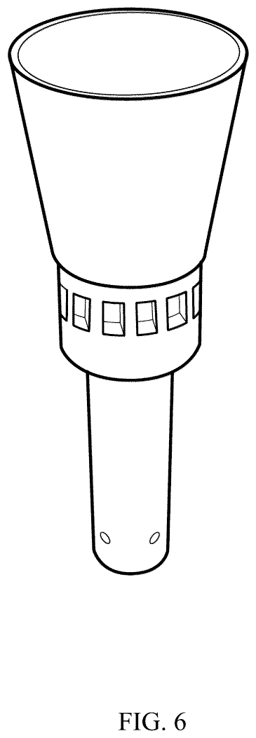

FIG. 6 demonstrates both parts joined together, forming the complete dryer attachment. This view is critical for understanding the full assembly and functionality of the tool, showing how the narrow end fits into the container while the flared section remains outside, connected to the blow dryer.

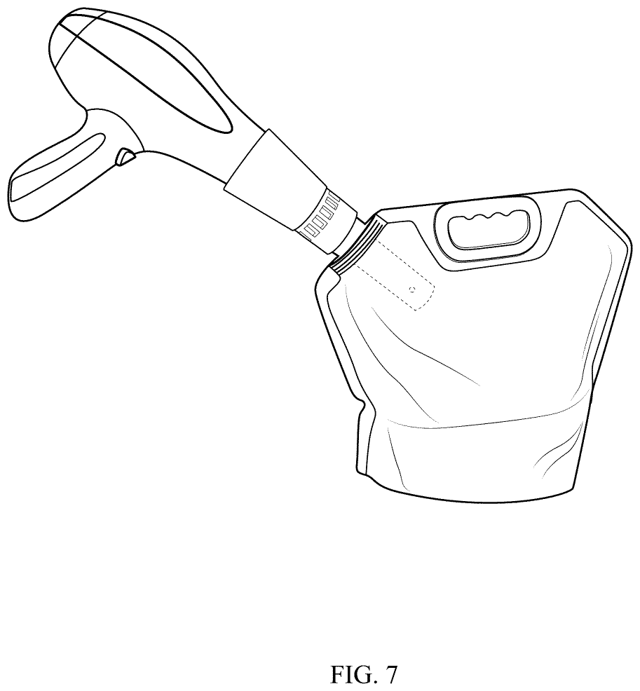

FIG. 7 offers a perspective view of the dryer assembly installed in a collapsible water container. This shows the practical application of the tool, where the narrow end is inserted into the container's opening, and the flared section is attached to a blow dryer, ready for operation. This view shows the continuity of airflow from the blow dryer through the attachment and into the container, demonstrating the seamless integration of both parts to provide the desired functionality effectively.

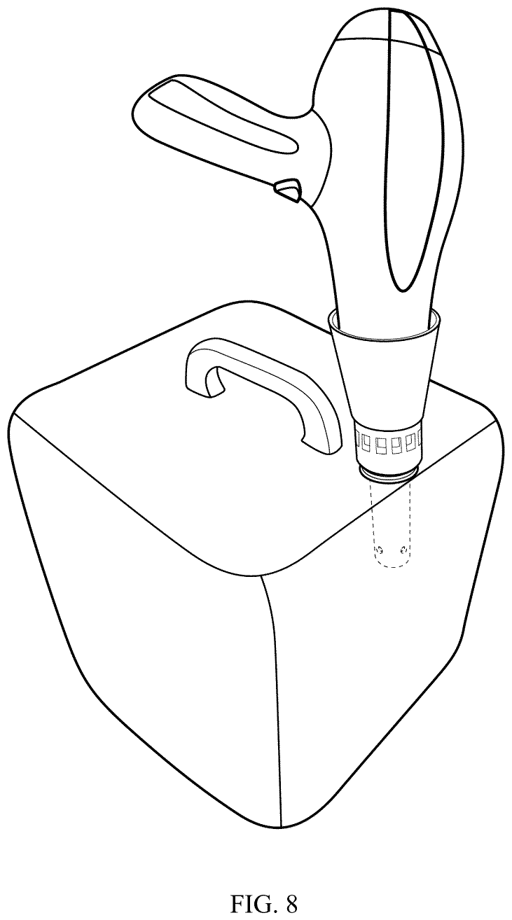

FIG. 8 illustrates a working view of the dryer in action. This view shows the blow dryer attached to the dryer tool, with airflow being directed into the container. The proposed assembly captures the operational phase where moist air is being dispersed efficiently out of the container through the side vents.

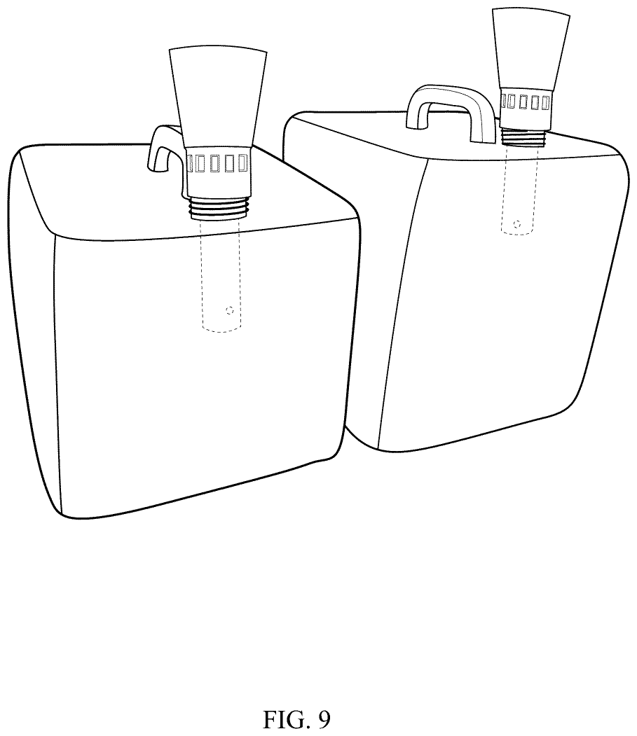

FIG. 9 provides another working view, focusing on the airflow distribution within the container. This view highlights the effectiveness of the small openings around the narrow end and the larger openings at the bottom in ensuring thorough drying of the container's interior.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A blow dryer attachment tool for drying collapsible water containers, comprising:
a. a narrow end adapted to fit into the opening of a collapsible water container;
b. a threaded section for securing the attachment to the container;
c. a flared opening designed to direct airflow from a blow dryer; and,
d. a plurality of small openings positioned around the narrow end to disperse airflow into the container.
The blow dryer attachment tool of claim 1, wherein the flared opening is configured to accommodate various sizes of blow dryer nozzles;
The blow dryer attachment tool of claim 1, wherein the narrow end forms a tight seal when inserted into the opening of the collapsible water container;
The blow dryer attachment tool of claim 1, wherein the assembly includes a plurality of larger openings located at the bottom of the attachment to disperse airflow across the bottom of the container;
The blow dryer attachment tool of claim 1, wherein the larger openings are arranged to disperse airflow in multiple directions;
The blow dryer attachment tool of claim 1, wherein the attachment is constructed from heat-resistant materials including plastic or silicone;
The blow dryer attachment tool of claim 1, wherein the attachment is lightweight and portable for convenient use in various settings;
The blow dryer attachment tool of claim 1, wherein the plurality of small openings strategically positioned to evenly distribute airflow throughout the container;
The blow dryer attachment tool of claim 1, wherein a plurality of side vents along the length of the attachment to efficiently disperse moist air out of the container;
The blow dryer attachment tool of claim 1, wherein the side vents prevent airflow obstruction by the blow dryer;
The blow dryer attachment tool of claim 1, wherein the attachment is detachable for storage and transport;
The blow dryer attachment tool of claim 1, wherein the assembly is compatible with blow dryers featuring cool or cold airflow settings;
The blow dryer attachment tool of claim 1, wherein the flared opening minimizes air leakage during operation;
The blow dryer attachment tool of claim 1, wherein the assembly is suitable for various shapes and sizes of collapsible water containers; and,
The blow dryer attachment tool of claim 1, wherein the assembly expedites the drying process of collapsible water containers, ensuring thorough drying for storage or reuse.
